(19) United States
(12) Patent Application Publication
(10) Pub. No.: US 2011/0219244 A1
(43) Pub. Date: Sep. 8, 2011

(54) POWER EXTRACTING SYSTEM AND A SPLITTER

(76) Inventors: Hsi-Mien Wu, Taipei (TW); Yu-Chun Chen, Danshuei Township (TW)

(21) Appl. No.: 12/718,127

(22) Filed: Mar. 5, 2010

(51) Int. Cl. G06F 1/00

(52) U.S. Cl. 713/300

(57) ABSTRACT

The invention discloses a power extracting system and a splitter. The power extracting system comprises a power sourcing equipment (PSE), an electric device, a power embedded communication line, and the splitter. The PSE provides a first DC power according to a triggering signal. The electric device is driven by a second DC power. The power embedded communication line, coupled to the PSE, transmits the first DC power and an Ethernet data. The splitter, coupled to the power embedded communication line, splitting the first DC power and the Ethernet data. The splitter comprises a converter and a simulating module. The converter receives the first DC power and supplies the second DC power to the electric device. The simulating module generates the triggering signal.

### BACKGROUND OF THE INVENTION

1. Field of the invention

The invention is related to a power extracting system and a splitter. More particularly, the invention is related to a power extracting system and a splitter which can simulate a powered device (PD) being connected.

2. Description of the prior art

With the increasing needs for internet, network devices are indispensable nowadays. To allow users access to the internet anytime, anywhere, a lots of network devices are required to be set up around rooms, buildings, subways, tunnels, everywhere. However, the network devices usually need power lines and Ethernet lines, wiring those lines further increases the difficulties while setting up the network devices.

In addition, certain electric devices such as notebooks might also require power and Ethernet data at the same time. If we can provide power and internet in a single cable, notebook users will no longer need to carry transformers and lan cables all the time, so that the users can use the notebooks more convenient. Thus, a cable which can provide power and Ethernet data simultaneously is required.

Traditional power extracting system can provide power and Ethernet data from a power sourcing equipment (PSE) to a powered device (PD) through a power embedded communication line. However, if the electric devices connected to the power embedded communication line do not support IEEE PoE standards, the PSE will not transmit power through the power embedded communication line. Therefore, each of the electric devices must be upgraded to fit the standards, and the cost might be huge to replace all of the electric devices. Furthermore, different electric devices usually work under different voltages, the traditional power embedded communication line cannot real-time detect the voltage required by each electric device unless the electric device fit the standards.

It is important that the deployment efficiency of the power extracting system need to be increased, so that every electric devices, whether the electric devices fit the IEEE PoE standards or not, can be powered in any place. Additionally, the power extracting system is required to be able to real-time detect and supply the power needed by each of the electric devices. The present invention provides several possible solutions to the problems mentioned above.

With the apparatus of the present invention, an odor can be generated corresponding to the situation to fulfill said demand of the consumer.

### SUMMARY OF THE INVENTION

An object of the present invention is to provide a power extracting system which is able to collocate with all kinds of electric devices for solving the problem of the prior art, wherein the electric devices are not necessary to fit PoE standards.

According to an embodiment of the present invention, the power extracting system comprises a power sourcing equipment (PSE), an electric device, a power embedded communication line, and a splitter. The PSE provides a first DC power according to a triggering signal. The electric device is driven by a second DC power. The power embedded communication line, coupled to the PSE, transmits the first DC power and an Ethernet data. The splitter, coupled to the power embedded communication line, splitting the first DC power and the Ethernet data. The splitter comprises a converter and a simulating module. The converter receives the first DC power and supplies the second DC power to the electric device. The simulating module generates the triggering signal.

Furthermore, the triggering signal indicates that the electric device supporting PoE functions, wherein the PoE functions follows the specifications in IEEE standard 802.3af, IEEE standard 802.3at, and IEEE standard 803.3at.

In addition, the simulating module can be a chipset for sending the corresponding triggering signal to the PSE according to which PoE standards the PSE applies. Besides, the simulating module can comprise a passive element which generates a voltage drop passively as the triggering signal. Further, the passive element can be a resistor approx 25 kΩ(25 k ohm).

Moreover, the splitter further comprises a detecting module. The detecting module, coupled to the electric device and the converter, detects the amount of the second DC power consumed by the electric device, and outputs a detecting signal to the converter to make a output power of the converter tally with the second DC power. Additionally, the splitter further comprises a first tubular part and a second tubular part. The first tubular part transmits the first DC power, and the second tubular part transmits the Ethernet data.

Another object of the present invention is to provide a splitter which is able to collocate with all kinds of electric devices, wherein the electric devices are not necessary to fit PoE standards.

Accordingly, the present invention is to provide a splitter. The splitter, coupled to a power sourcing equipment (PSE) by a power embedded communication line, splits a first DC power and an Ethernet data, and the first DC power is outputted by the PSE. The splitter comprises a converter and a simulating module. The converter receives the first DC power and supplies a second DC power to an electric device. The simulating module, coupled to the PSE, outputs a triggering signal to the PSE, wherein the PSE provides the first DC power according to the triggering signal.

To sum up, the splitter of the power extracting system can simulate the triggering signal indicates that the electric device supporting PoE functions, so that every electric devices, whether the electric devices fit the PoE standards or not, can be powered in any place. Additionally, the power extracting system is able to real-time detect and supply the power needed by each of the electric devices.

The objective of the present invention will no doubt become obvious to those of ordinary skill in the art after reading the following detailed description of the preferred embodiment, which is illustrated in following figures and drawings.

### BRIEF DESCRIPTION OF THE APPENDED DRAWINGS

FIG. 1 illustrates a block diagram of a power extracting system according to an embodiment of the invention.

FIG. 2 illustrates a block diagram of a power extracting system according to another embodiment of the invention.

FIG. 3 illustrates the flow chart of the test program for determining the amount of the second DC power consumed by the network device according to an embodiment of the invention.

### DETAILED DESCRIPTION OF THE INVENTION

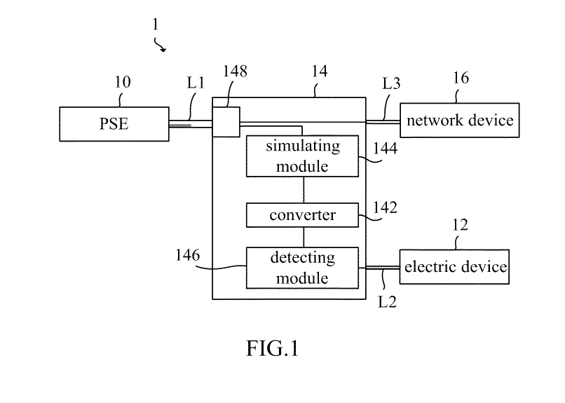

Please refer to FIG. 1. FIG. 1 illustrates a block diagram of a power extracting system according to an embodiment of the invention. As shown in FIG. 1, the power extracting system 1 comprises a power sourcing equipment (PSE) 10, an electric device 12, a splitter 14, a network device 16, a power embedded communication line L1, a first tubular part L2, and a second tubular part L3, wherein the power extracting system 1 can be, but not limited to, a Power-over-Ethernet (PoE) system or a Power-over-Cable (PoC) system. The first tubular part L2 is applied to transmit a first DC power to the electric device 12, and the second tubular part L3 is applied to transmit an Ethernet data to the network device 16. Moreover, the splitter 14 further comprises a converter 142, a simulating module 144, a detecting module 146, and a receiving connector 148.

The PSE 10, coupled to the splitter 14 by the power embedded communication line L1, provides a first DC power according to a triggering signal. In practice, the PSE 10, such as a PoE switch/router, can provide up to 15.4 W of DC power (minimum 44 V DC and 350 mA) to the electric device 14 in compliance with the IEEE 802.3af PoE standard. It should be noticed that IEEE PoE standards mentioned in this invention could be, but not limited to, IEEE 802.3af, 802.3at, 803.3at, or other appropriate PoE standards.

The electric device 12, coupled to the splitter 14 by the first tubular part L2, driven by a second DC power. In practice, the electric device 12 in this invention can be employed whether it fit the IEEE PoE standards or not. For example, the electric device 12 can be a non-PoE device or a private standard PoE device. The electric device 12 can be, but not limited to, a notebook, a network device, an IP phone, or other appropriate devices.

The power embedded communication line L1, coupled between the PSE 10 and the splitter 14, transmitting the first DC power and an Ethernet data. In practice, the power embedded communication line L1 is a cable, providing a single connection to the splitter 14, to carry DC power and Ethernet signals. Moreover, the power embedded communication line L1 can be, but not limited to, a twist pair cable, a category 3 (CAT-3) cable, a category 5 (CAT-5) cable, a category 6 (CAT-6) cable or a coaxial cable.

The splitter 14 splits the first DC power and the Ethernet data by the receiving connector 148. The receiving connector 148, coupled to the power embedded communication line L1, receives and splits the first DC power and the Ethernet data. In practice, the receiving connector 148 usually tallies with the type of the power embedded communication line L1. There are several types of receiving connector 148 correspond to different types of the power embedded communication line L1. For example, the receiving connector 148, such as RJ-45, is used for connecting category 5 (CAT-5) cable correspondingly. Thus, the receiving connector 148 can be, but not limited to, RJ11, RJ14, RJ45, or F-type connector, or other types of connectors.

The simulating module 144, coupled to the receiving connector 148, generates the triggering signal for indicating that the electric device 12 supports PoE functions. On the other hand, the triggering signal can also indicate that the electric device 12 uses proprietary PoE specifications. In practice, the simulating module 144 can be a chipset or a passive element for generating the triggering signal. The simulating module 144 is a chipset, for example, for sending the corresponding triggering signal to the PSE 10 according to which PoE standards the PSE 10 applies. Otherwise, the simulating module 144 can further comprise a passive element which generates a voltage drop passively as the triggering signal, wherein the passive element can be a resistor, or have an equivalent resistance, approx 25 kΩ(25 k ohm).

The converter 142, coupled to the PSE 10, receives the first DC power and supplies the second DC power to the electric device 12. In practice, the converter 142 is used to adjust the original voltage supplied by the PSE 10 to the suitable voltage the electric device 12 required. In other words, the converter 142 can automatically downgrade the voltage supplied by the PSE to the specific voltage the electric device 12 required.

It should be noticed that users can also set the splitter 14 manually to drive the converter 142 outputs specific voltages. For example, when the user already knew the required voltage of the electric device 12, the user can tune the splitter 14 to output said required voltage.

The detecting module 146, coupled to the electric device 12 and the converter 142, detects the amount of the second DC power consumed by the electric device 12, and outputs a detecting signal to the converter 142 to make a output power of the converter tally with the second DC power. In practice, there are some methods for the detecting module 146 to detects the amount of the second DC power consumed by the electric device 12. For example, certain specifications, such as the requirements of voltage, current, and power, of electric devices 12 can be preset in the first place, the detecting module 146 only needs to supply the corresponding voltage, current, and power after recognizing which electric device 12 is connected. If the electric device 12 is not able to be recognized by the detecting module 146, the detecting module 146 still can perform a test program to determine the amount of the second DC power consumed by the electric device 12.

The network device 16 can receive/transmit the Ethernet data through the second tubular part L3. In practice, because the receiving connector 148 splits the first DC power and the Ethernet data, the second tubular part L3 transmits the Ethernet data only. Further, the second tubular part L3 can be, but not limited to, a LAN cable or other appropriate cable to transmit the Ethernet data. Moreover, when a notebook is connected to the splitter, the notebook can be the electric device 12 and the network device 16 at the same time. To be specific, the first tubular part L2 can be connected to a DC connector, and the second tubular part L3 can also be connected to a network connector of the notebook. Thus, the notebook can be powered and can access the internet at the same time.

It should be noticed that, the network device 16 sometimes can also receive the first DC power from the splitter 14, that is, if the network device 16 can fit the PoE standards, it can be connected to the power embedded communication line L1 directly; if the network device 16 cannot fit the PoE standards, it can still be powered by applying the splitter 14 to let the network device 16 receive the power and the Ethernet data separately. In practice, the network device 16 may only have certain PoE functions, that is, the network device 16 is not necessary to fit any PoE standards but to fit proprietary PoE specifications.

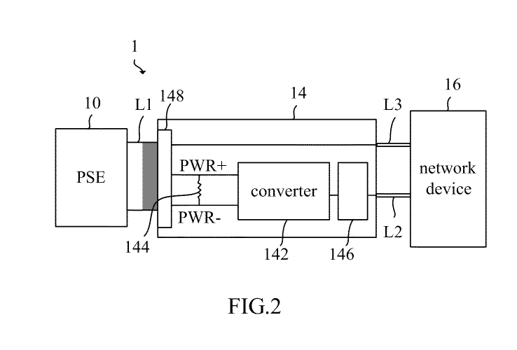

Please refer to FIG. 2. FIG. 2 illustrates a block diagram of a power extracting system according to another embodiment of the invention. As shown in figures, the passive element is connected across the high voltage line (PWR+) and the low voltage line (PWR−) to generate the voltage drop passively as the triggering signal. In the other hand, as long as the PSE 10 senses the voltage drop as the triggering signal, the PSE 10 considers that a powered device (PD) is connected, and the PSE 10 may send the first DC power along the power embedded communication line. Furthermore, the network device 16 can be, but not limited to, a wireless AP or a network switch.

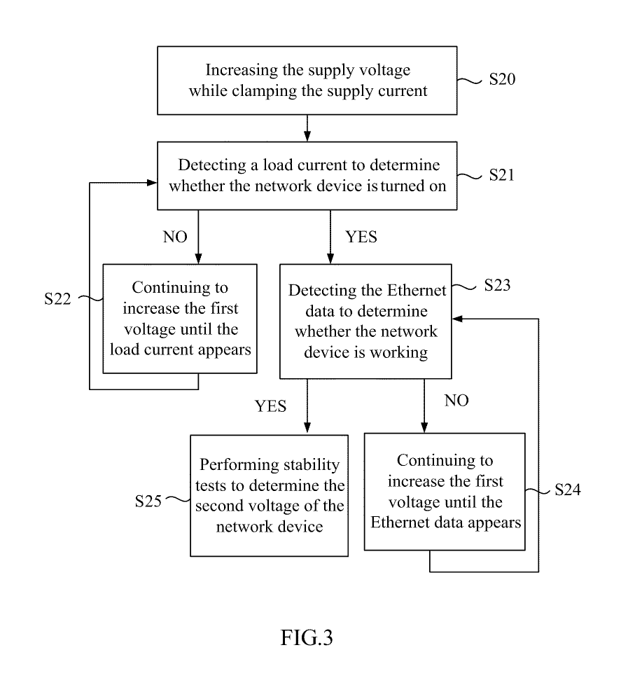

Moreover, please refer to FIG. 2 and FIG. 3. FIG. 3 illustrates the flow chart of the test program for determining the amount of the second DC power consumed by the network device 16 according to an embodiment of the invention. As shown in FIG. 2 and FIG. 3, the detecting module 146 provides the network device 16 a relative small voltage (under 3V) in the first place. In step S20, the detecting module 146 increases the supplied voltage while clamping the supplied current (<100 mA). In practice, the detecting module 146 increases the supplied voltage by 0.1V within a time span. In step S21, after increasing the supplied voltage, the detecting module 146 detects a load current to determine whether the network device 16 is turned on. If the load current remains, that indicates the network device 16 is not turned on.

In step S22, after determining that the network device 16 is not turned on, the detecting module 146 continues to increase the first voltage until the load current of the network device 16 appears. In step S23, if the network device 16 is turned on, the detecting module 146 unleashes the supplied current, and the detecting module 146 further detects the Ethernet data to determine whether the network device 16 is working properly. In practice, the network device 16 can usually be determined whether it is working by testing the Ethernet data is transmitted properly or not.

In step S24, if the detecting module 146 detects no Ethernet data transmitted from the network device 16, the detecting module 146 continues to increase the first voltage until the Ethernet data appears. In step S24, if the Ethernet data transmitted from the network device 16 can be detected, the detecting module 146 performs stability tests to determine the second voltage of the network device 16. In practice, when the detecting module 146 detects the Ethernet data transmitted from the network device 16, the supplied voltage is recorded as a reference voltage to performs stability tests. To be specific, the detecting module 146 can adjust the reference voltage slightly to see at what voltage the detecting module 146 can receive the strongest Ethernet data, that is, the detecting module 146 can confirm the second voltage in a short time or real-time.

To sum up, the present invention is to provide the power extracting system which comprises the splitter to simulate the triggering signal, so that every electric devices, whether the electric devices fit the IEEE PoE standards or not, can be powered in any place. Additionally, the power extracting system is able to real-time detect and supply the power needed by each of the electric devices. It is convenience that the splitter of this invention can replace the transformer of the electric device which needs to connect to the network. Furthermore, users can remote control the electric devices connected to the splitter of the present invention by turning on/off the PSE, that is, power cycling devices can also be replaced by the power extracting system of the present invention. Moreover, because the splitter of the present invention can monitor whether the electric devices are working, the fee for maintaining the electric devices can be greatly reduced. Additionally, the power extracting system of the present invention can make the deployment and the trouble shooting of the electric devices more convenient, especially in a complex environment.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A power extracting system, comprising:
a power sourcing equipment (PSE) providing a first DC power according to a triggering signal;
an electric device driven by a second DC power;
a power embedded communication line, coupled to the PSE, transmitting the first DC power and an Ethernet data; and
a splitter, coupled to the PSE by the power embedded communication line, splitting the first DC power and the Ethernet data, and the splitter comprising:
a converter, coupled to the PSE, receiving the first DC power and supplying the second DC power to the electric device; and
a simulating module, coupled to the PSE, generating the triggering signal.

2. The power extracting system of claim 1, wherein the simulating module is a chipset for sending the corresponding triggering signal to the PSE according to which PoE standards the PSE applies.

3. The power extracting system of claim 1, wherein the simulating module comprises a passive element which generates a voltage drop passively as the triggering signal.

4. The power extracting system of claim 3, wherein the passive element is a resistor approx 25 kΩ(2 5k ohm).

5. The power extracting system of claim 1, wherein the splitter further comprises:
a detecting module, coupled to the electric device and the converter, detects the amount of the second DC power consumed by the electric device, and outputs a detecting signal to the converter to make a output power of the converter tally with the second DC power.

6. The power extracting system of claim 1, wherein the splitter further comprises:
a first tubular part for transmitting the first DC power; and
a second tubular part for transmitting the Ethernet data.

7. The power extracting system of claim 1, wherein the triggering signal indicates that the electric device supporting PoE functions.

8. The power extracting system of claim 8, wherein the PoE functions follows the specifications in IEEE standard 802.3af, IEEE standard 802.3at, and IEEE standard 803.3at.

9. The power extracting system of claim 8, wherein the triggering signal indicates that the electric device using proprietary PoE specifications.

10. The power extracting system of claim 1, wherein the splitter further comprises a receiving connector for receiving the first DC power and the Ethernet data, and transmitting the first DC power to the converter.

11. A splitter, coupled to a power sourcing equipment (PSE) by a power embedded communication line, for splitting a first DC power and an Ethernet data, the first DC power being outputted by the PSE, and the splitter comprising:
a converter, coupled to the PSE, receiving the first DC power and supplying a second DC power to an electric device; and
a simulating module, coupled to the PSE, outputting a triggering signal to the PSE, wherein the PSE providing the first DC power according to the triggering signal.

12. The power extracting system of claim 11, wherein the simulating module is a chipset for sending the corresponding triggering signal to the PSE according to which PoE standards the PSE applies.

13. The power extracting system of claim 11, wherein the simulating module comprises a passive element which generates a voltage drop passively as the triggering signal.

14. The power extracting system of claim 13, wherein the passive element is a resistor approx 25 kΩ(25 k ohm).

15. The power extracting system of claim 11, wherein the splitter further comprises:
a detecting module, coupled to the electric device and the converter, detects the amount of the second DC power consumed by the electric device, and outputs a detecting signal to the converter to make a output power of the converter tally with the second DC power.

16. The power extracting system of claim 11, wherein the splitter further comprises:
a first tubular part for transmitting the first DC power; and
a second tubular part for transmitting the Ethernet data.

17. The power extracting system of claim 11, wherein the triggering signal indicates that the electric device supporting PoE functions.

18. The power extracting system of claim 17, wherein the PoE functions follows the specifications in IEEE standard 802.3af, IEEE standard 802.3at, and IEEE standard 803.3at.

19. The power extracting system of claim 17, wherein the triggering signal indicates that the electric device using proprietary PoE specifications.

20. The power extracting system of claim 11, wherein the splitter further comprises a receiving connector for receiving the first DC power and the Ethernet data, and transmitting the first DC power to the converter.
